(19) United States
(12) Patent Application Publication
(10) Pub. No.: US 2017/0321749 A1
(43) Pub. Date: Nov. 9, 2017

(54) NON-CANTILEVERED MAGNETIC BEARING FOR DRUM-SHAPED VERTICAL ROTORS

(71) Applicant: SKF Canada Limited, Scarborough (CA)

(72) Inventors: Daren P. Tremaine, Silverton (CA); Jeffrey Russell Smithanik, Calgary (CA)

(21) Appl. No.: 15/590,980

(22) Filed: May 9, 2017

Related U.S. Application Data
(60) Provisional application No. 62/333,594, filed on May 9, 2016.

(51) Int. Cl. F16C 32/04

(52) U.S. Cl. CPC F16C 32/0485; F16C 32/0468; F16C 32/0402; F16C 32/0446; F16C 2316/10

(57) ABSTRACT

A magnetic bearing assembly is for levitating a generally drum-shaped, vertical rotor such that the drum itself is the target of magnetic actuators. The magnetic bearing assembly basically includes at least one active radial actuator configured to center the drum-shaped rotor in an annular air gap so as to enable contactless rotation. The one or more radial actuators are configured to act principally against gravity and is/are located in essentially the same vertical plane as a center of gravity of the drum-shaped rotor.

### BACKGROUND OF THE INVENTION

The present invention relates to bearings, and more particularly to magnetic bearings for rotors.

Magnetic bearings are generally known and include one or more actuators which exert magnetic force on a member to enable contactless rotation or linear displacement. Such bearings enable high rotational speeds compared to conventional bearings.

### SUMMARY OF THE INVENTION

The present invention is a configuration of magnetic levitation bearings for circular drums, specifically for computed tomography (CT) scanners, which eliminates forces on the bearings due to cantilevered loads. In this invention, the radial and axial magnetic bearings impart force directly onto the rotating drum, with the radial bearing forces being substantially located in the same vertical plane as the center of gravity (“CG”) of the drum.

In one aspect, the present invention is magnetic bearing assembly for levitating a generally drum-shaped, vertical rotor such that the drum itself is the target of magnetic actuators. The magnetic bearing assembly comprises at least one active radial actuator configured to center the drum-shaped rotor in an annular air gap so as to enable contact free rotation. The at least one actuator is configured to act principally against gravity and is located in essentially the same vertical plane as a center of gravity of the drum.

### BRIEF DESCRIPTION OF THE SEVERAL VIEWS OF THE DRAWINGS

The foregoing summary, as well as the detailed description of the preferred embodiments of the present invention, will be better understood when read in conjunction with the appended drawings. For the purpose of illustrating the invention, there is shown in the drawings, which are diagrammatic, embodiments that are presently preferred. It should be understood, however, that the present invention is not limited to the precise arrangements and instrumentalities shown. In the drawings:

FIG. 1 is a front perspective view of a scanner drum with a magnetic bearing assembly in accordance with a first construction of the present invention;

FIG. 2 is a rear perspective view of the scanner drum and first construction magnetic bearing assembly;

FIG. 3 is a broken-away, enlarged axial cross-sectional view through line 3-3 of FIG. 1;

FIG. 4 is a broken-away, enlarged axial cross-sectional view through line 4-4 of FIG. 1;

FIG. 5 is a front perspective view of a scanner drum with a magnetic bearing assembly in accordance with a second construction of the present invention;

FIG. 6 is a rear perspective view of the scanner drum and second construction magnetic bearing assembly;

FIG. 7 is a broken-away, enlarged axial cross-sectional view through line 7-7 of FIG. 5;

FIG. 8 is a broken-away, enlarged axial cross-sectional view through line 8-8 of FIG. 5;

FIG. 9 is a front perspective view of a scanner drum with a magnetic bearing assembly in accordance with a third construction of the present invention;

FIG. 10 is a rear plan view of the scanner drum and third construction magnetic bearing assembly;

FIG. 11 is a broken-away, enlarged axial cross-sectional view through line 11-11 of FIG. 9;

FIG. 12 is a broken-away, enlarged axial cross-sectional view through line 12-12 of FIG. 9;

FIG. 13 is a front perspective view of a scanner drum with a magnetic bearing assembly in accordance with a fourth construction of the present invention;

FIG. 14 is a rear plan view of the scanner drum and fourth construction magnetic bearing assembly;

FIG. 15 is a broken-away, enlarged axial cross-sectional view through line 16-16 of FIG. 13; and

FIG. 16 is a broken-away, enlarged axial cross-sectional view through line 16-16 of FIG. 13.

### DETAILED DESCRIPTION OF THE INVENTION

The present invention is for use with machines where a drum-shaped rotor, potentially with a hollow profile, must rotate. Examples include CT X-ray scanners, silicon wafer saws, and others.

The problems sought to be solved are as follows:
1) CT scanners contain, in drum shaped rotor, an x-ray source, and an x-ray detector, on opposite sides of the drum, 180 degrees away from each other. The plane of the drum is typically vertical, with the rotation axis being perpendicular to the plane of the drum and horizontal. Traditional CT scanners employ a rolling element bearing axially displaced from the drum. With the bulk of the mass and C of G of a CT scanner rotor in the drum, and the radial bearing supporting the weight being some distance from the center of gravity (“C of G”), gravity creates a tilting moment on the drum, due to the cantilevered load. This is done to minimize the diameter and cost of the rolling element bearing.
   In a magnetic bearing, where segmenting allows the diameter to not be linked to the bearing cost, these cantilevered loads require large or more magnetic actuators, driving costs and complexity up. This invention allows magnetic bearings to be placed above the C of G of the rotor (drum), thus eliminating the cantilevered loads.
2) The flexibility of CT scanner drums and stationary frames, inherent in large, multi-body structures, means they are poor support structures for magnetic bearings, which require relatively stiff structures to act against. If the forces demanded of magnetic bearings can be reduced, they and their control system can tolerate a more flexible structure.

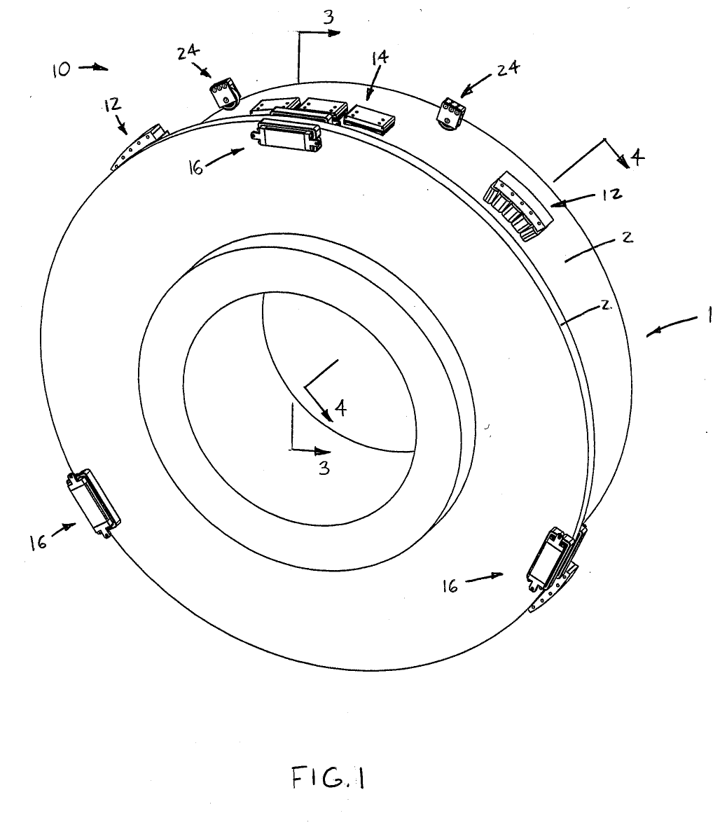

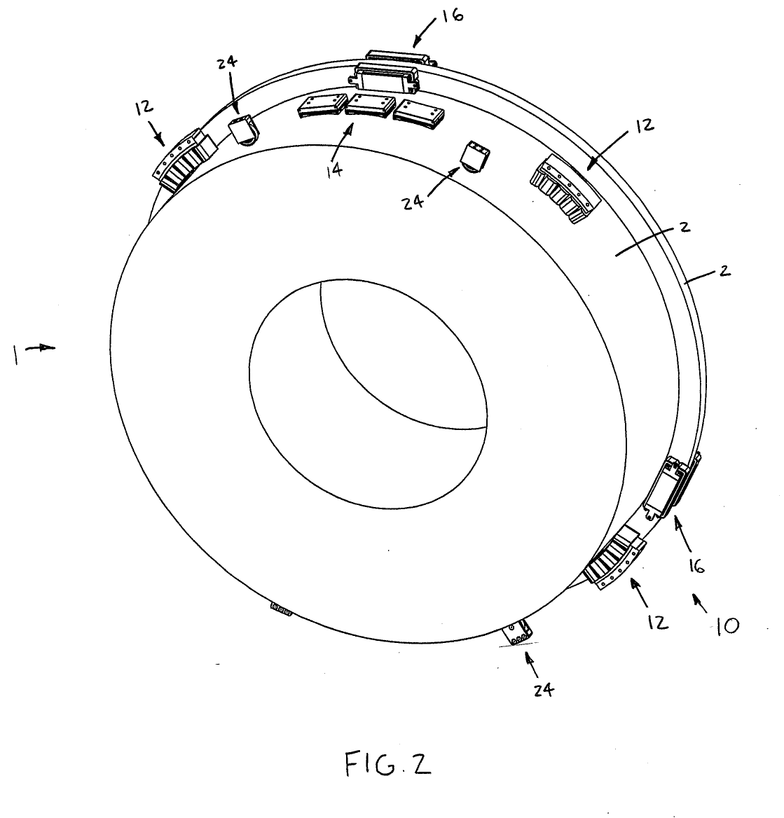

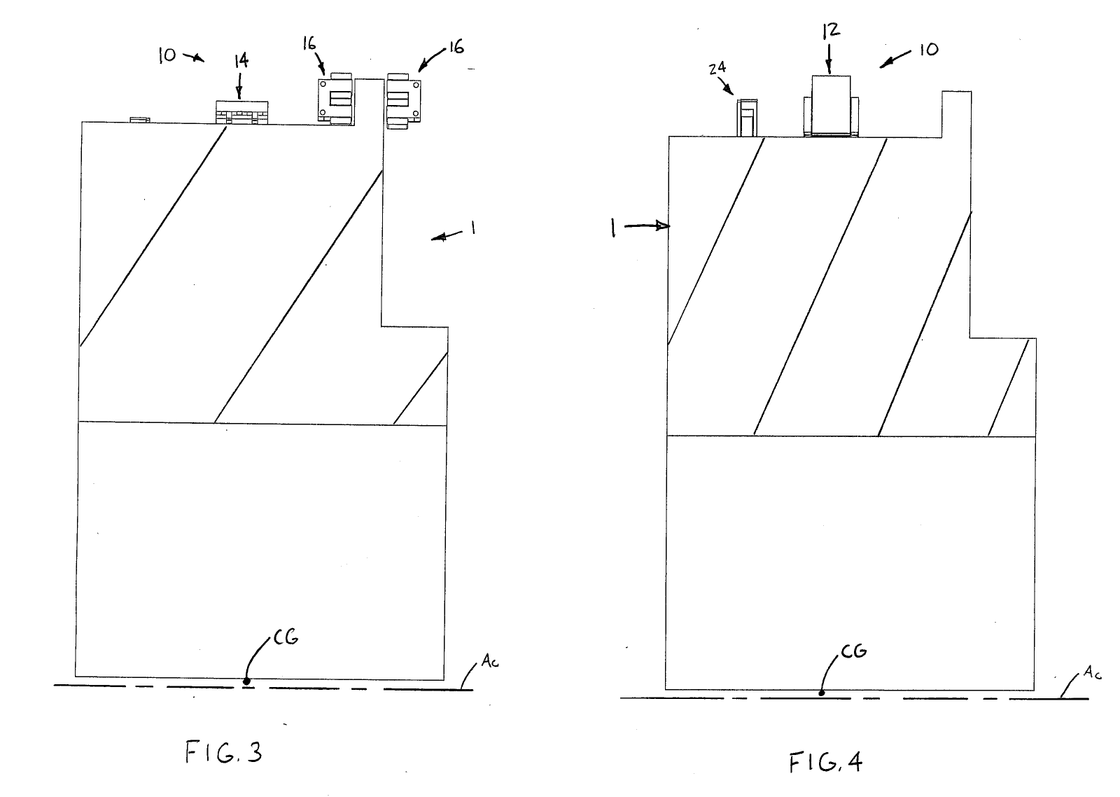

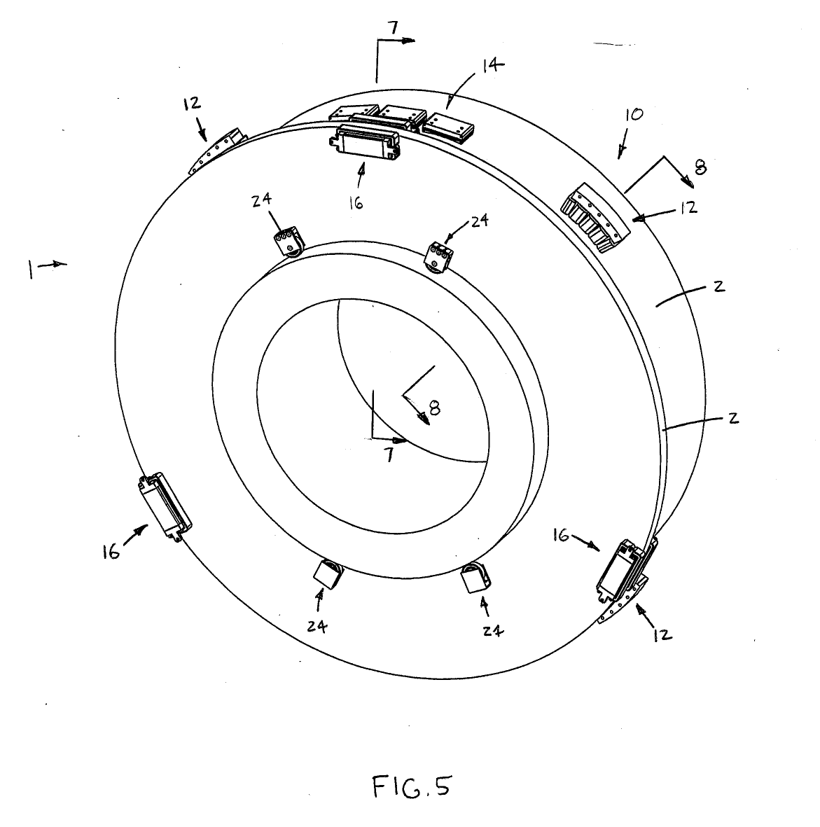

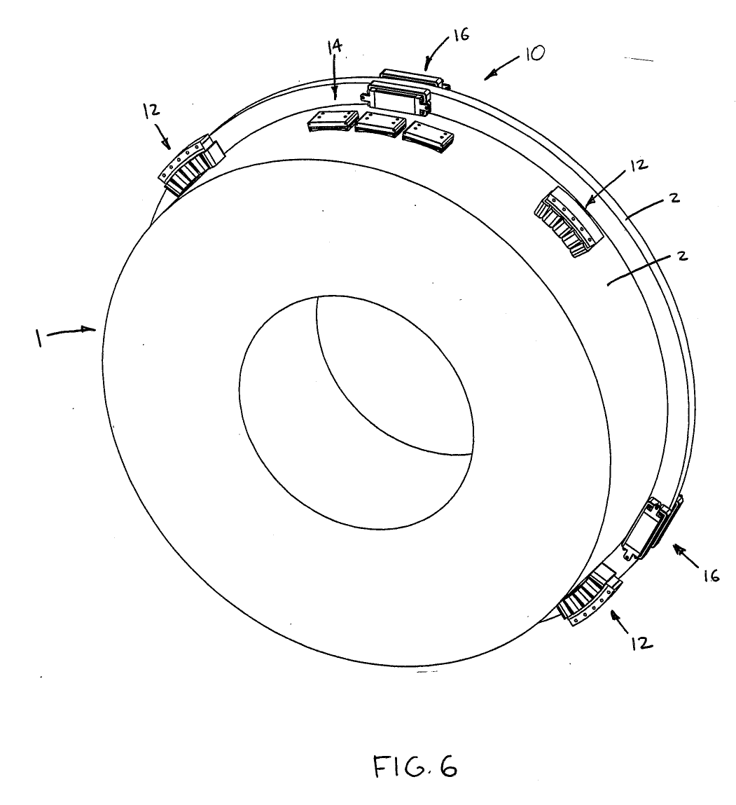

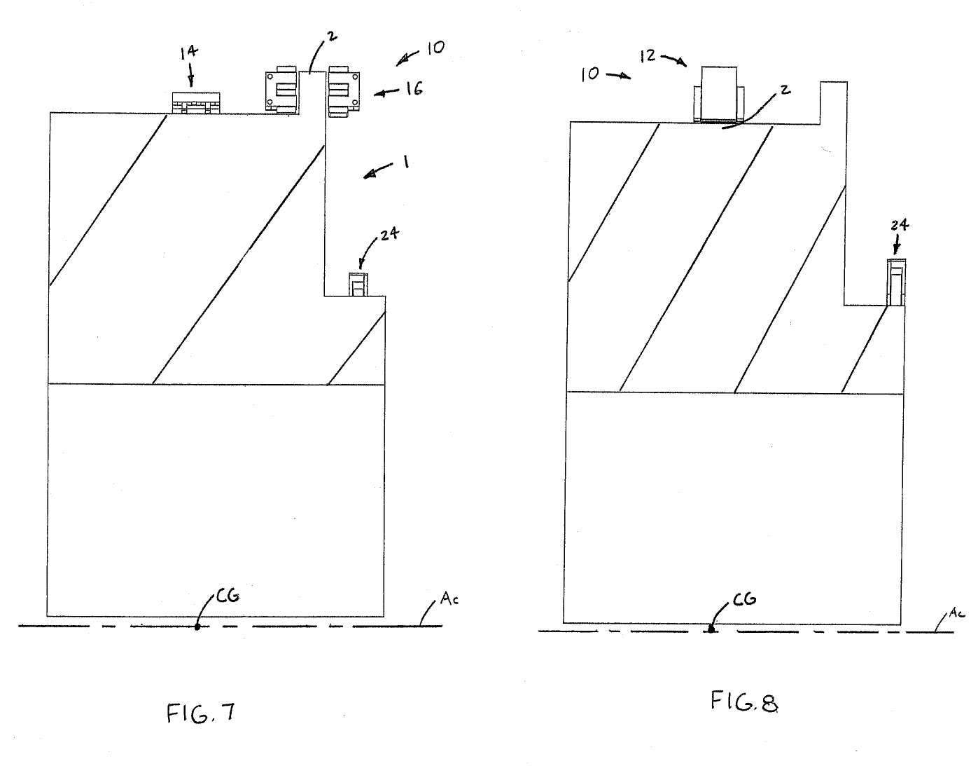

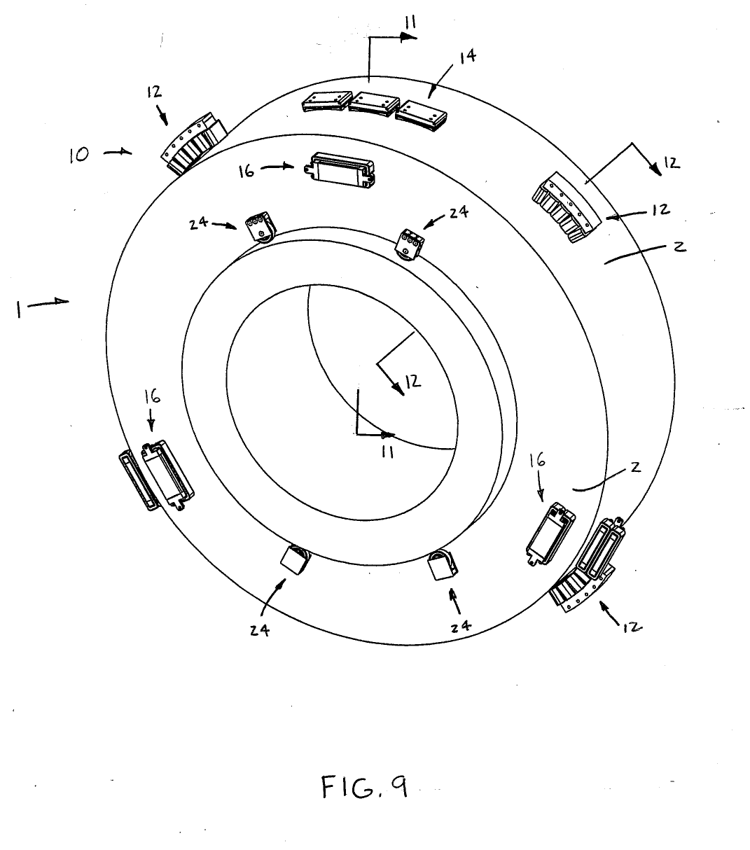

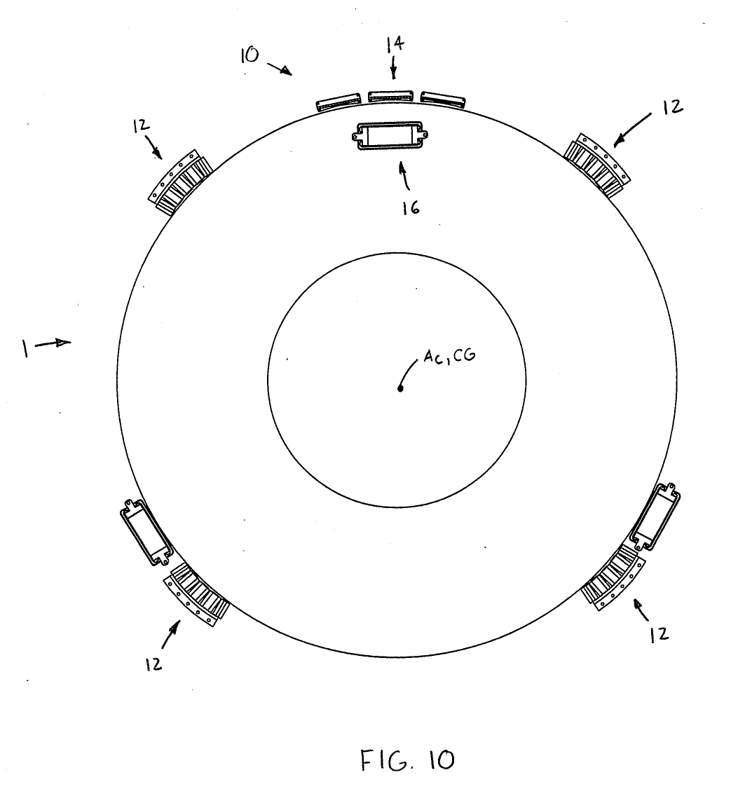

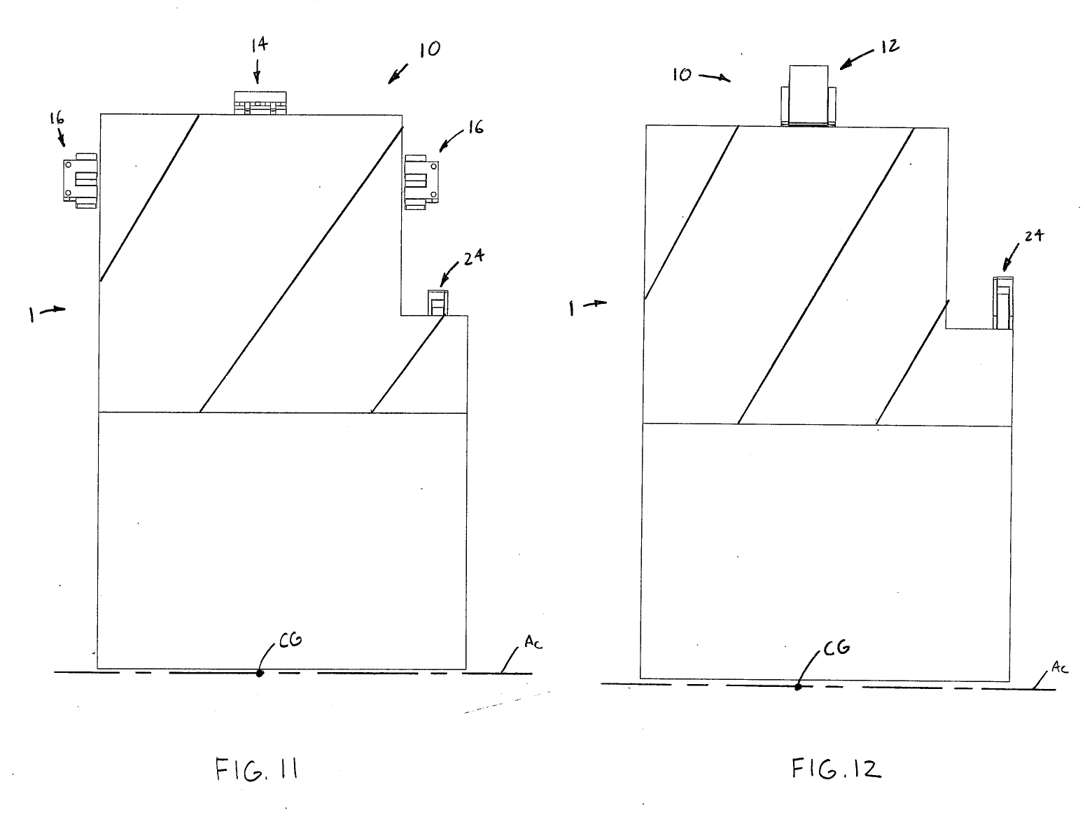

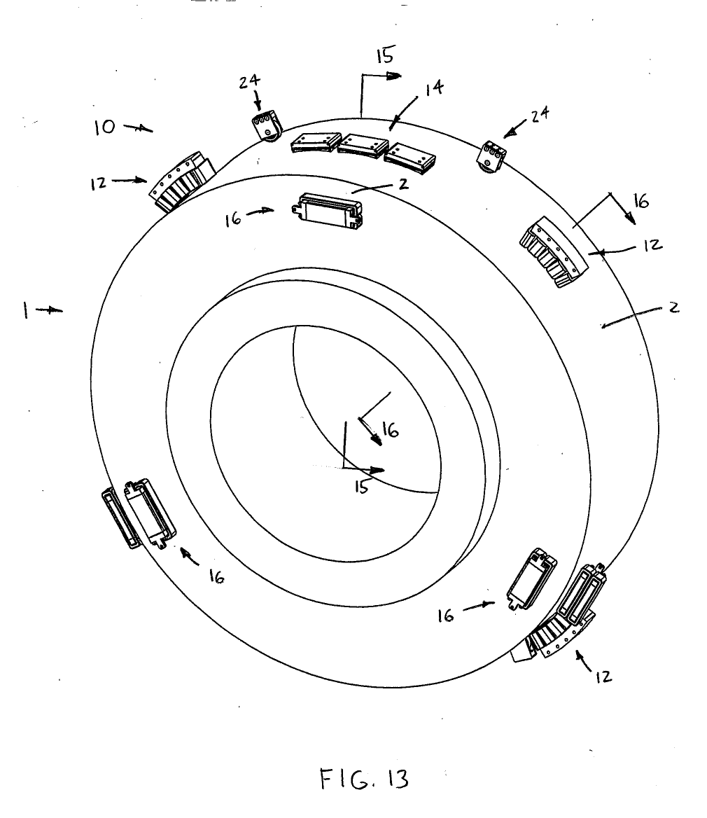

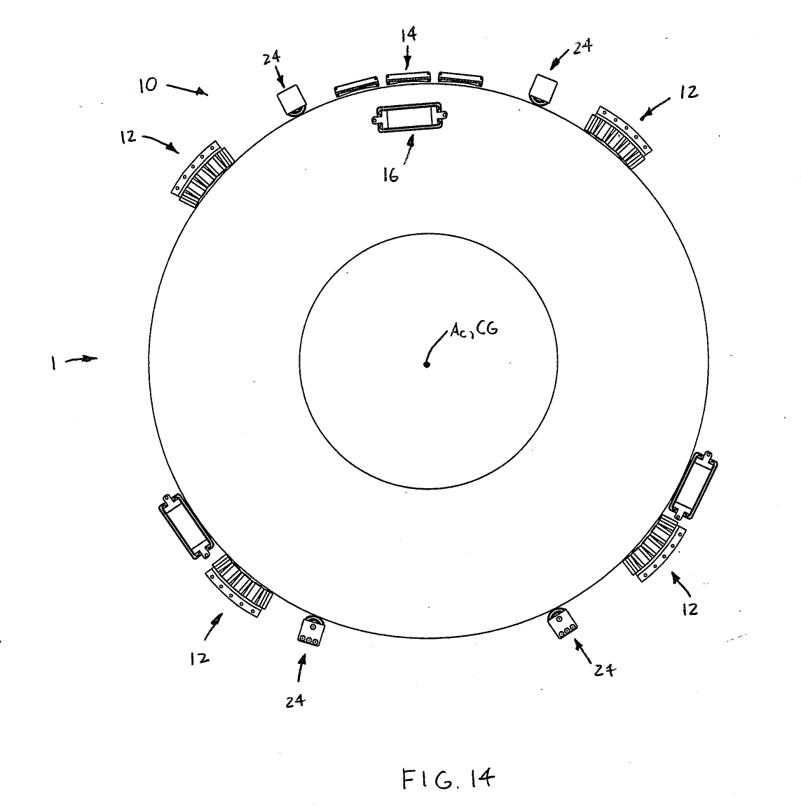

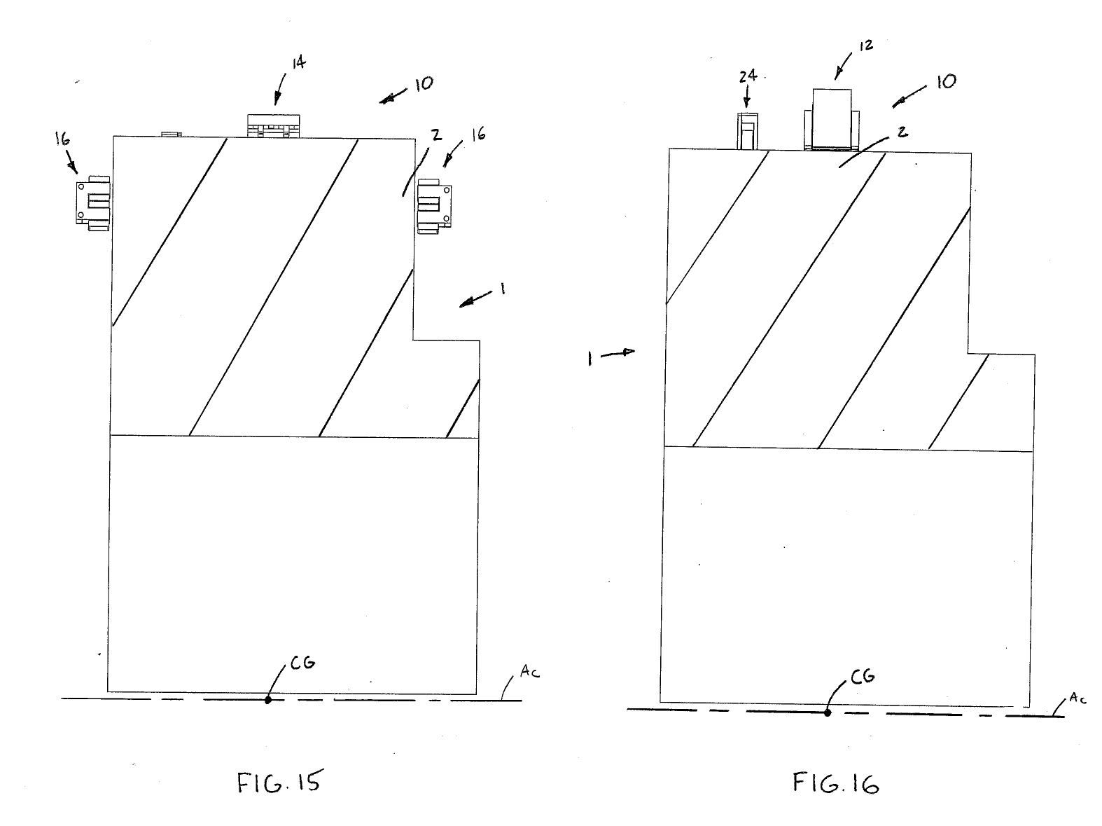

Referring now to the drawings in detail, wherein like numbers are used to indicate like elements throughout, there is shown in FIGS. 1-16 a magnetic bearing assembly 10 for levitating a generally drum-shaped, vertical rotor 1, preferably a CT scanner drum, which is rotatable about a central axis A_{C} and preferably has at least one ferromagnetic section 2, such that the drum 1 itself is the target of magnetic actuators. The magnetic bearing assembly 10 basically comprises at least one active radial actuator 12 configured to center the drum-shaped rotor 1 in an annular air gap G_{A} so as to enable contactless rotation about the axis A_{C}. The at least one radial actuator 12 is configured to act principally against gravity and being located in essentially the same vertical plane as a center of gravity CG of the drum 1. The magnetic bearing assembly 10 preferably further comprises at least one passive radial actuator 14 configured to substantially off-load vertical loads due to gravity and located in substantially in the same plane as the center of gravity CG of the drum 1 so as to reduce work required of the active actuators 12. Preferably, the bearing assembly 10 also further comprises at least one active axial actuator 16 configured to generally center the drum-shaped rotor 1 in the air gap G_{A} so as to enable contactless rotation. Further, each of the active magnetic actuators 12, 16 and the passive magnetic actuator(s) 14 are each configured to attract the ferromagnetic drum section 2.

Preferably, the bearing assembly 10 also further comprises a least one position sensor 18 configured to sense the radial and axial position of the drum-shaped rotor 1 and also configured to transmit electronic signals corresponding to the radial and axial positions to a magnetic bearing controller 20. As such, the bearing assembly 10 preferably also includes the magnetic bearing controller 20, which is configured to receive the position signals from the position sensor(s) 18 and further configured to control the electrical currents in the active magnetic actuators 12, 16. Further, at least one sensor target 22 is disposed on the drum-shaped rotor 1 and the at least one position sensor 18 is configured to sense the at least one sensor target.

Furthermore, the bearing assembly 10 preferably further comprises an “arrest” or backup bearing system 24 configured to temporarily support the drum-shaped rotor 1 in the event of failure in the magnetic levitation system, i.e., the active and passive actuators 12, 16 and 14. Preferably, the arrest bearing system 24 includes rolling elements or sliding elements (not shown).

### Features of the Invention

Magnetic bearings which levitate a drum-shaped, vertical rotor such that the drum itself is the target of the magnetic actuators, with the radial actuators, comprised of:
1) At least one or more active radial actuators, centering the drum-shaped rotor in an annular air gap to allow contact free rotation, which act principally against gravity and are placed in essentially the same vertical plane as the center of gravity (“CG”) of the drum.
2) Optionally one or more passive radial actuators, to substantially off-load vertical loads due to gravity, being placed substantially in the same plane as the CG of the drum, easing the work of the active actuators.
3) At least one or more active axial actuators, centering the drum-shaped rotor in an air gap, to allow contact free rotation.
4) One or more position sensors, which, together or individually, can sense the radial and axial position of the rotating drum, and can report those positions through electronic signals, to a magnetic bearing controller (MBC).
5) A ferromagnetic section on the rotating drum, which can be attracted by the active and/or passive magnetic actuators.
6) A suitable sensor target on the rotating drum, supporting the operation of the position sensors.
7) An MBC which can read the position sensor signals and control the electrical currents in the active magnetic actuators.
8) An arrest bearing system, either using rolling or sliding elements, to temporarily support the rotating drum in the event of failure in the levitation system

### Advantages of the Present Invention

The present invention takes advantage of the ability of magnetic bearings to be easily segmented and deployed to very large diameter rotors, compared to rolling element bearings where large diameters result in high costs.

The present invention greatly reduces the force demand and thus size and cost of magnetic actuators for a CT scanner levitation system. This also decreases the structural rigidity requirement of the CT scanner rotor and frame.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as generally defined in the appended claims.

We claim:

1. A magnetic bearing assembly for levitating a generally drum-shaped, vertical rotor such that the drum itself is the target of magnetic actuators, the magnetic bearing assembly comprising:
at least one active radial actuator configured to center the drum-shaped rotor in an annular air gap so as to enable contactless rotation of the rotor, the at least one actuator being configured to act principally against gravity and being located in essentially the same vertical plane as a center of gravity of the drum-shaped rotor.

2. The magnetic bearing assembly as recited in claim 1 further comprising at least one passive radial actuator configured to substantially off-load vertical loads due to gravity and located in substantially in the same plane as the center of gravity of the drum so as to reduce work required of the active actuators.

3. The magnetic bearing assembly as recited in claim 1 further comprising at least one active axial actuator configured to generally center the drum-shaped rotor in an air gap so as to enable contact free rotation.

4. The magnetic bearing assembly as recited in claim 1 further comprising at least one position sensor configured to sense the radial and axial position of the drum-shaped rotor and configured to transmit electronic signals corresponding to the radial and axial positions to a magnetic bearing controller.

5. The magnetic bearing assembly as recited in claim 4 further comprising a magnetic bearing controller configured to receive the position signals from the position sensors and configured to control the electrical currents in the active magnetic actuators.

6. The magnetic bearing assembly as recited in claim 1 wherein the drum-shaped rotor includes a ferromagnetic section, at least one of the active magnetic actuators and the passive magnetic actuators being configured to attract the ferromagnetic drum section.

7. The magnetic bearing assembly as recited in claim 1 further comprising at least one sensor target disposed on the drum-shaped rotor, the at least one position sensor being configured to sense the at least one sensor target.

8. The magnetic bearing assembly as recited in claim 1 further comprising an arrest bearing system configured to temporarily support the drum-shaped rotor in the event of failure in the levitation system.

9. The magnetic bearing assembly as recited in claim 8 wherein the arrest bearing system includes one of rolling elements and sliding elements.
